(19) United States
(12) Patent Application Publication
(10) Pub. No.: US 2019/0040542 A1
(43) Pub. Date: Feb. 7, 2019

(54) SURFACE MODIFICATION DEVICE BASED ON ELECTROPHORESIS-ASSISTED MICRO-NANO PARTICLE MELTING AND SELF-ASSEMBLY

(71) Applicant: GUANGDONG UNIVERSITY OF TECHNOLOGY, GUANGZHOU (CN)

(72) Inventors: Junfeng HE, GUANGZHOU (CN); Zhongning GUO, GUANGZHOU (CN); Li LIU, GUANGZHOU (CN)

(73) Assignee: GUANGDONG UNIVERSITY OF TECHNOLOGY

(21) Appl. No.: 16/153,773

(22) Filed: Oct. 7, 2018

Related U.S. Application Data
(63) Continuation of application No. PCT/CN2017/099463, filed on Aug. 29, 2017.

(30) Foreign Application Priority Data
Apr. 25, 2017 (CN) 201710277890.4
Apr. 25, 2017 (CN) 201720443553.3

(51) Int. Cl. C25D 13/22; C25D 13/20; C25D 15/00; C25D 17/06; C25D 21/12

(52) U.S. Cl. CPC C25D 13/22; C25D 13/20; B82Y 30/00; C25D 17/06; C25D 21/12; C25D 15/00

(57) ABSTRACT

A surface modification device based on electrophoresis-assisted micro-nano particle melting and self-assembly, includes a working table, a particle and solution mixing and circulating container, a processing recess, a solution conveying apparatus, an electrophoresis-assisted apparatus, a vacuum heating apparatus and an integrated control cabinet. Sacrifice particles with a relatively low melting point are in a molten state. The molten particles cover or are adhered to another type of modified particles and the surface of the metal workpiece, so that the binding force between the metal workpiece and micro-nano particles is enhanced. By taking advantage of characteristics of the modified particles, hydrophilic and hydrophobic micro structures are obtained on the metal surface. The electrophoresis-assisted apparatus may greatly improve the deposition efficiency of extremely fine particles in a solution. The deposition rate and the deposition thickness may be adjusted by adjusting the intensity of an electric field.

### CROSS-REFERENCE TO RELATED APPLICATIONS

This application is a continuation of international application PCT/CN2017/099463 filed Aug. 29^{th} 2017, further claims priority to Chinese Patent Application No. 201710277890.4 and Chinese Patent Application No. 201720443553.3 both with a filing date of Apr. 25, 2017. The content of the aforementioned applications, including any intervening amendments thereto, are incorporated herein by reference.

### TECHNICAL FIELD

The prevent disclosure relates to the field of surface modification, and particularly to a surface modification device based on electrophoresis-assisted micro-nano particle melting and self-assembly.

### BACKGROUND OF THE PRESENT INVENTION

In current society, materials are applied to all aspects of life and production. Different materials have their own characteristics and application ranges. As the most commonly used material, metal is widely applied to various fields of product processing. However, metal materials have inherent defects. The failure of the metal materials usually comes from surfaces in the most common failure forms such as wear, corrosion and breakage. Surface characteristics of the metal material mainly depend on a processing technology for the metal material, so that a formed product easily has performance defects or shortcomings due to technological characteristics, processing quality and the like. In order to improve surface properties such as intensity, hardness, rigidity, wear resistance and corrosion resistance of the metal material, the metal material is required to be post-treated to meet use and performance requirements.

With rapid development of modern sciences and technologies, there is an increasing demand for the surface properties of the metal material, so that new development and extension for a surface treatment technology and process have been made. Surface modification for a hydrophilic bionic structure, a hydrophobic bionic structure and the like on the surface of a metal workpiece is a relatively popular surface technology. As a “lotus effect” of a hydrophobic surface is discovered, a superhydrophobic material is widely used in aspects such as self cleaning, freeze protection, fog prevention, corrosion prevention, blocking prevention, microfluidic chips and lossless liquid conveying, thereby representing a wide application prospect of the superhydrophobic material.

At present, most superhydrophobic surfaces are prepared by an electrochemical corrosion method or a chemical corrosion method to construct rough structures required by superhydrophobic surfaces. The electrochemical corrosion method includes preparing a regular rough surface through anode oxidation, and then preparing a superhydrophobic surface by modification through a low-surface-energy substance. This method is applicable to a wide range of materials and high in controllability, but has relatively harsh conditions. Since most of used electrolyte solutions are acid or alkali mixed solutions with relatively high corrosivity, and a relatively large amount of electrolyte solution may be consumed, it is a trouble to recycle waste liquid, and this method is unfavorable for industrial production. The chemical corrosion method includes forming a rough structure for the surface through chemical corrosion by adopting nitric acid, hydrochloric acid, hydrofluoric acid and the like at first, then constructing a nano structure for the surface through thermal treatment, and finally preparing a superhydrophobic surface by modification through a low-surface-energy substance. The chemical corrosion method is simple and feasible, but substances used as corrosive liquid are high in corrosivity, so that it is a trouble to treat waste liquid, which limits the development of the chemical corrosion method.

Self-assembling of metal and functional molecules in nano size has a wide application prospect in nano electronic devices in the future. Researches on a basic theory and actual application of self-assembling are becoming an emerging research field. At present, nanoparticles are generally subjected to surface modification which enables the particles to be widely applied to all fields: magnetofluid, colored imaging, magnetic recording materials and biomedicines. The nanoparticles are easy to agglomerate in organisms and easy to clear away by a reticuloendothelial system (RES), and may easily adsorb plasma proteins due to their surface hydrophobicity and relatively large body surface ratios, so that the nanoparticles are required to be subjected to surface modification to improve the hydrophilcity and prolong the cycle half-life period. There are many substances applied to surface modification, which are generally organic matters and also may be inorganic matters and proteins or antibodies and the like. At present, the nanoparticles are in one of the most active directions in the field of nano materials for biomedicines. Nanoparticles prepared by different methods have biomedical applications in many aspects after being subjected to surface modification by different polymers or molecules.

Existing metal surface modification methods generally include a thermal sintering method and a nickel salt thermal decomposition method. The thermal sintering method includes soaking a carbon material into a modification substance-containing liquid phase, and then melting a modification substance to enable the modification substance to be combined with a carbon surface through thermal treatment at a medium or high temperature, thereby adjusting the hydrophilcity and the hydrophobicity of the carbon surface. This method mainly improves the hydrophobicity through polytetrafluoroethylene treatment and improves the hydrophilcity through amine substance treatment.

During thermal treatment, a molten substance may protect surface structures of the material, so that this method has little influence on the surface structures of the carbon material. An atomic force microscope (AFM) represents and indicates that melted polyethylene polyamine may protect a carbon fiber surface and has a deformation smaller than that of carbon fiber which is only subjected to thermal treatment. In the aspect of chemical constitution, elements and radical groups in the modification substance are introduced into the carbon surface through the thermal sintering method. In the aspect of hydrophilic modification, an amino functional group is introduced into the carbon surface during ammoniation treatment, and exists mainly in an acylamino form. Amino may form hydrogen bonds together with water and an epoxy group of epoxy resin after being introduced into the carbon fiber surface, thereby greatly improving the wettability. In the aspect of hydrophobic modification, after polytetrafluoroethylene (PTFE) is attached to the carbon surface, a fluorocarbon group is introduced. With increase of the PTFE content, a hydrophilic and hydrophobic balance may be better realized. The thermal sintering method for regulating and controlling the hydrophilicity and the hydrophobicity has the advantages of simple and convenient steps and short time.

The nickel salt thermal decomposition method includes adsorbing Ni²⁺ onto the surface of a matrix at first, and then performing thermal decomposition on nickel salt to obtain a nickel catalysis center. People activate hollow glass microbeads with an activation solution, which is prepared from nickel sulfate and sodium hypophosphite, under an ultrasonic-assisted condition for 2 min, and then perform thermal oxidation reduction at 175° C. for 50 min, so as to successfully realize palladium-free activation for chemically nickel-plated phosphorus alloy by the hollow glass microbeads. Then people soak ceramic microbeads with the activation solution for 30 min, and also perform thermal oxidization reduction at 175° C. for 50 min, thereby realizing palladium-free activation for the chemically nickel-plated phosphorus alloy on the surfaces of the ceramic microbeads.

The thermal sintering method has the shortcomings that high-temperature treatment is required, resulting in relatively high cost, and the modification substance may be attached unevenly in the soaking process, easily resulting in non-uniformity of the hydrophilicity and hydrophobicity properties on the surface of the treated carbon material. The nickel salt thermal decomposition method has the shortcomings of inapplicability to matrix materials with relatively low melting point and only applicability to heat resistant substances such as ceramic, glass and carbonate silicon. Meanwhile, chemical reagents used in the nickel salt thermal decomposition method are low-surface-energy modifiers which are pollutants, causing that this method is dangerous in operation. Direct grinding pretreatment and thermal treatment reduce the roughness of the metal surface.

How to provide a metal surface modification device capable of enhancing a binding force between a metal surface and nanoparticles is a technical problem that is required to be solved by those skilled in the art at present.

### SUMMARY OF PRESENT INVENTION

The present disclosure aims to provide a surface modification device based on electrophoresis-assisted micro-nano particle melting and self-assembly capable of enhancing a binding force between a metal surface and nanoparticles.

In order to solve the above-mentioned technical problem, the present disclosure provides a surface modification device based on electrophoresis-assisted micro-nano particle melting and self-assembly, including: a working table; a particle and solution mixing and circulating container, mounted on the working table and used for mixing nanoparticles with a solution; a processing recess, mounted on the working table and used for placing a metal workpiece to be processed; a solution conveying apparatus, used for conveying the nanoparticle solution to a surface of the metal workpiece to be processed; an electrophoresis-assisted apparatus, mounted on the working table and respectively connected with an electrophoresis-assisted cathode and the metal workpiece to be processed in a conducting manner, wherein an electrophoresis-assisted electric field for depositing the nanoparticles is formed between the metal workpiece to be processed and the electrophoresis-assisted cathode; a vacuum heating apparatus, mounted on the working table and used for heating the metal workpiece to be processed to melt part of the nanoparticles on the surface of the metal workpiece to be processed; and an integrated control cabinet with a controller arranged therein, wherein the controller is in communication connection with and controls the particle and solution mixing and circulating container, the solution conveying apparatus and the vacuum heating apparatus.

Preferably, an ultrasonic vibration apparatus for vibrating the nanoparticles, a magnetic stirring apparatus for stirring the nanoparticle solution, a suspension suction apparatus for guiding the nanoparticle solution, and a solution circulating apparatus for filtering and circulating the nanoparticle solution are arranged in the particle and solution mixing and circulating container.

Preferably, a micro three-dimensional motion platform in communication connection with the controller is mounted on the working table. The processing recess is mounted on the micro three-dimensional motion platform, and moves synchronously with the micro three-dimensional motion platform to align the metal workpiece to be processed with the solution conveying apparatus.

Preferably, a workpiece clamp for clamping the metal workpiece to be processed is fixedly mounted on an upper side of a bottom plate of the processing recess.

Preferably, a main shaft is arranged on the working table. The solution conveying apparatus includes a suction pipe and a suction pipe clamp. An opening defined on one end of the suction pipe is communicated with the particle and solution mixing and circulating container. The suction pipe clamp is configured to clamp the other end of the suction pipe, so that an opening defined on the other end of the suction pipe is aligned with the metal workpiece to be processed. The suction pipe clamp is mounted on the main shaft, and is movable along the main shaft.

Preferably, a cathode clamp is mounted on the main shaft. The cathode clamp is configured to clamp the electrophoresis-assisted cathode. One output end of the electrophoresis-assisted apparatus is connected with the cathode clamp, and the other output end of the electrophoresis-assisted apparatus is connected with the workpiece clamp.

Preferably, a keyboard and a display screen which are in communication connection with the controller are arranged outside the integrated control cabinet.

Preferably, a video detecting apparatus used for detecting states of the nanoparticles on the surface of the metal workpiece to be processed is mounted on the working table.

Preferably, the video detecting apparatus includes a bracket mounted on the working table and a charge coupled image sensor mounted on the bracket.

The surface modification device based on electrophoresis-assisted micro-nano particle melting and self-assembly according to the present disclosure includes the working table, the processing recess, the solution conveying apparatus, the electrophoresis-assisted apparatus, the vacuum heating apparatus and the integrated control cabinet. The particle and solution mixing and circulating container is mounted on the working table and is used for mixing the nanoparticle with the solution. The processing recess is mounted on the working table and is used for placing a metal workpiece to be processed. The solution conveying apparatus is used for conveying the nanoparticle solution to a surface of the metal workpiece to be processed. The electrophoresis-assisted apparatus is mounted on the working table and is respectively connected with an electrophoresis-assisted cathode and the metal workpiece to be processed in a conducting manner, and an electrophoresis-assisted electric field for depositing the nanoparticles is formed between the metal workpiece to be processed and the electrophoresis-assisted cathode. The vacuum heating apparatus is mounted on the working table and is used for heating the metal workpiece to be processed to melt part of the nanoparticles on the surface of the metal workpiece to be processed. A controller is arranged in the integrated control cabinet. The controller is in communication connection with and controls the particle and solution mixing and circulating container, the solution conveying apparatus and the vacuum heating apparatus.

The nanoparticles and the solution are fully mixed in the particle and solution mixing and circulating container to for nanoparticle solution. Then the nanoparticle solution is conveyed to the surface of a metal surface to be processed to enable the mixed nanoparticles to be deposited on the metal surface at one time or multiple times, thereby obtaining an ordered micro particle arrangement. Next, the surface temperature of the workpiece is changed through the vacuum heating apparatus to enable sacrifice particles with a relatively low melting point to be in a molten state. The molten particles cover or are adhered to another type of modified particles and the surface of the metal workpiece, so that the binding force between the metal workpiece and the micro-nano particles is enhanced. By use of characteristics of the modified particles, hydrophilic and hydrophobic micro structures are obtained on the metal surface. Meanwhile, for extremely fine particles of extremely small sizes, the Brownian motion of the particles is counteracted with the gravity action, which enables the particles to be in a relatively balanced state in the suspension without being deposited or enables the particles to be extremely low in deposition rate and relatively low in efficiency, so that the electrophoresis-assisted electric field formed by the electrophoresis-assisted apparatus is used for applying certain electric field action to the particles through an electrophoresis effect of the micro particles. Electrophoresis deposition has the advantages of convenience in control, no special requirement for types of particles and surface states of the particles and the like, so that migration and adsorption of the mixed micro-nano particles may be performed on any irregular metal surfaces such as a plane, a curved surface, a boss and a groove, or different types of particles may be migrated and adsorbed for multiple times. The deposition efficiency of the extremely fine particles in the solutions may be greatly improved. The deposition rate and the deposition thickness may be adjusted by adjusting the intensity of the electric field.

### DESCRIPTION OF THE DRAWINGS

FIG. 1 is a structural schematic diagram of one specific implementation mode of a surface modification device based on electrophoresis-assisted micro-nano particle melting and self-assembly according to the present disclosure.

### DETAILED DESCRIPTION OF PREFERRED EMBODIMENTS

The core idea of the present disclosure is to provide a surface modification device based on electrophoresis-assisted micro-nano particle melting and self-assembly capable of enhancing a binding force between a metal surface and nanoparticles.

To make those skilled in the art better understand solutions of the present disclosure, the present disclosure is further described below in detail in combination with drawings and specific embodiments.

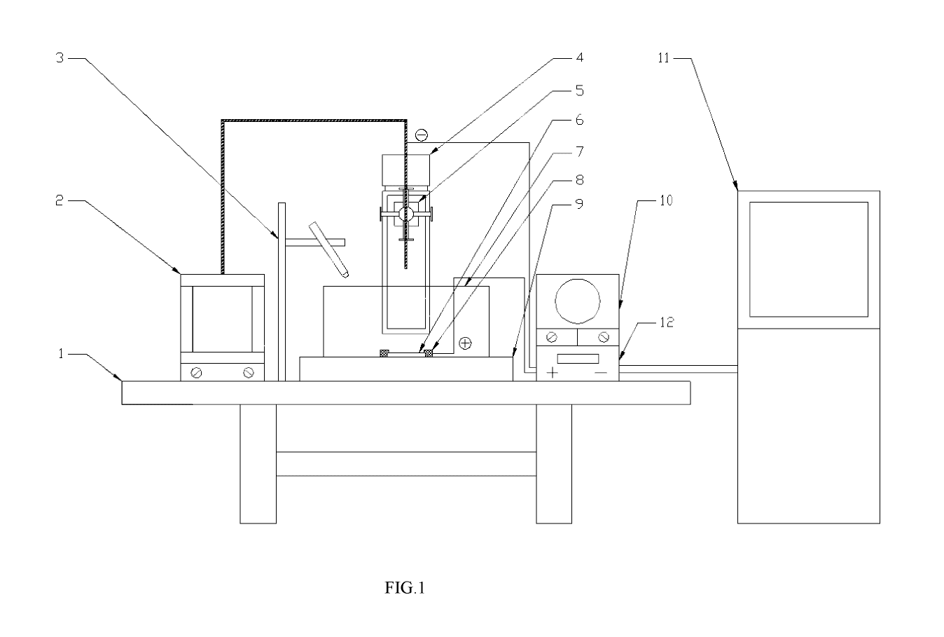

Referring to FIG. 1, FIG. 1 is a structural schematic diagram a surface modification device based on electrophoresis-assisted micro-nano particle melting and self-assembly according to embodiments of the present disclosure.

The specific embodiments of the present disclosure provides a surface modification device based on electrophoresis-assisted micro-nano particle melting and self-assembly, including a working table 1, a particle and solution mixing and circulating container 2, a processing recess 7, a solution conveying apparatus, an electrophoresis-assisted apparatus 12 and a vacuum heating apparatus 10.

The particle and solution mixing and circulating container 2 is mounted on the working table 1 and is used for mixing nanoparticles with a solution. Specifically, an ultrasonic vibration apparatus for vibrating the nanoparticles, a magnetic stirring apparatus for stirring the nanoparticle solutions, a suspension suction apparatus for guiding the nanoparticle solutions, and a solution circulating apparatus for filtering and circulating the nanoparticle solutions are arranged in the particle and solution mixing and circulating container 2. Full mixing of same particles or different particles may be realized.

The particles are in nano scale, and the nano-scale particles are fully fused in the solution through ultrasonic vibration and magnetic stirring to fully mix different types of nano-scale metal particles or different types of nano-scale nonmetal particles or different types of nano-scale metal and nonmetal particles in the solution.

The processing recess 7 is mounted on the working table 1 and is used for placing a metal workpiece 6 to be processed. Specifically, a micro three-dimensional motion platform 9 in communication connection with the controller is mounted on the working table 1. The processing recess 7 is mounted on the micro three-dimensional motion platform 9, and moves synchronously with the micro three-dimensional motion platform 9 to align the metal workpiece 6 to be processed with the solution conveying apparatus. The micro three-dimensional motion platform 9 may enable the processing recess 7 to do directed motion accurately, thereby guaranteeing relative positions of the processing recess 7 and a main shaft 4 and accurately placing the suspension onto the metal workpiece 6 to be processed before processing. In order to guarantee the stability during processing, a workpiece clamp 8 for clamping the metal workpiece 6 to be processed is fixedly mounted on the upper side of a base plate of the processing recess 7.

The solution conveying apparatus is used for conveying the nanoparticle solution to a surface of the metal workpiece 6 to be processed. Specifically, the main shaft 4 is arranged on the working table 1. The solution conveying apparatus includes a suction pipe and a suction pipe clamp 5. An opening defined on one end of the suction pipe is communicated with the particle and solution mixing and circulating container 2. The suction pipe clamp 5 is configured to clamp the other end of the suction pipe, so that an opening defined on the other end of the suction pipe is aligned with the metal workpiece 6 to be processed. The suction pipe clamp 5 is mounted on the main shaft 4, and is movable along the main shaft 4. The main shaft 4 is conveniently combined with the particle and solution mixing and circulating container 2, so that the mixed suspension of the nanoparticle solution is sucked from the particle and solution mixing and circulating container 2 to the surface of the metal workpiece 6 to be processed through the suction pipe clamp 5 connected with the main shaft 4. The mixed solution may be placed on the surface of the metal workpiece 6 to be processed at one time or multiple times.

The electrophoresis-assisted apparatus 12 is mounted on the working table 1 and is respectively connected with an electrophoresis-assisted cathode and the metal workpiece 6 to be processed in a conducting manner. An electrophoresis-assisted electric field for depositing the nanoparticles is formed between the metal workpiece 6 to be processed and the electrophoresis-assisted cathode. Specifically, a cathode clamp 5 is mounted on the main shaft 4. The cathode clamp 5 is configured to clamp the electrophoresis-assisted cathode. One output end of the electrophoresis-assisted apparatus 12 is connected with the cathode clamp 5 and is used as a cathode, and the other output end of the electrophoresis-assisted apparatus 12 is connected with the workpiece clamp 8. In addition, during processing, alternating current or direct current power is fed to form an assistant electric field between the metal workpiece 6 to be processed and the cathode to assist the particles in ordered deposition and improve the deposition efficiency. Different cathodes may be switched on line to form electrophoresis-assisted electric fields together with different workpieces, thereby realizing electrophoresis-assisted deposition.

Certain electric field action is applied to the particles through an electrophoresis effect of the micro particles. Electrophoresis deposition has advantages of convenience in control, no special requirement for types of particles and surface states of the particles and the like, so that migration and adsorption of the mixed micro-nano particles may be performed on any irregular metal surfaces such as a plane, a curved surface, a boss and a groove, or different types of particles may be migrated or adsorbed for multiple times. The deposition efficiency of extremely fine particles in the solution may be greatly improved. The deposition rate and the deposition thickness may be adjusted by adjusting the intensity of the electric field.

Under the electric field action, two-dimensional ordering for colloid particles on a solid-liquid interface has a common nature of maintaining the stability of colloids on the interface. An external direct current voltage or a square wave pulse has an obvious influence on depositional structures of the particles, and an assembling process is regulated through the external direct current voltage or the square wave pulse, thereby enhancing control over the orderliness of the two-dimensional depositional structures. Under the condition of applying an external alternating/direct current electric field perpendicular to the interface, the colloid particle suspension may form various ordered curved-surface or planar structures on the interface.

The vacuum heating apparatus 10 is mounted on the working table 1 and is used for heating the metal workpiece 6 to be processed to melt part of the nanoparticles on the surface of the metal workpiece 6 to be processed. The mixed suspension is placed onto the metal workpiece 6 to be processed through the suction pipe. Different types of particles are deposited on the surface of the metal workpiece 6 to be processed at one time or multiple times to obtain an ordered micro particle arrangement, and then the workpiece is placed into the vacuum heating apparatus 10 for heating the workpiece to a melting temperature of sacrifice particles with a relatively low melting point. Different particles have different melting temperatures, so that only a specific type of particles may be melted into a molten state under specific temperature control. The molten particles cover or are adhered to another type of modified particles, and this type of particles are “welded” with the metal workpiece, thereby effectively enhancing the binding force, forming micro-nano nested structures and achieving a particle melting and self-assembling effect, so as to achieve effects of performing surface hydrophilcity and hydrophobicity modification on the surface of the metal workpiece by using the micro-nano particles and enhancing the binding force between the particles and the metal workpiece.

A controller is arranged in an integrated control cabinet 11. The controller is in communication connection with and controls the particle and solution mixing and circulating container 2, the solution conveying apparatus and the vacuum heating apparatus 10. The controller controls the work of all the apparatuses. Specifically, a keyboard and a display screen which are in communication connection with the controller are arranged outside the integrated control cabinet 11. Various functions of the device may be realized by setting different apparatuses, and shall fall within the protection scope of the present disclosure.

On the basis of the surface modification device based on electrophoresis-assisted micro-nano particle melting and self-assemblies according to all the above-mentioned specific implementation modes, a video detecting apparatus 3 used for detecting states of the nanoparticles on the surface of the metal workpiece 6 to be processed may be further mounted on the working table 1, so that a surface deposition condition of the metal workpiece 6 to be processed and a distribution condition of the particles in the molten state may be detected in real time. Specifically, the video detecting apparatus 3 includes a bracket mounted on the working table 1 and a charge coupled image sensor mounted on the bracket, so as to improve the detecting accuracy. Other types of video detecting apparatuses may be also adopted for detecting, and shall fall within the protection scope of the present disclosure.

The surface modification device based on electrophoresis-assisted micro-nano particle melting and self-assembly according to the present disclosure is described above in detail. Specific examples are used herein for describing the principle and the implementation modes of the present disclosure. Descriptions of above embodiments are only used for helping to understand methods and core ideas of the present disclosure. It should be noted that those ordinary skilled in the art can also make several improvements and modifications to the present disclosure without departing from the principle of the present disclosure. These improvements and modifications shall also fall within the protection scope of claims of the present invention.

We claim:

1. A surface modification device based on electrophoresis-assisted micro-nano particle melting and self-assembly, comprising:
a working table (1);
a particle and solution mixing and circulating container (2), mounted on the working table (1) and used for mixing nanoparticles with a solution;
a processing recess (7), mounted on the working table (1) and used for placing a metal workpiece (6) to be processed;
a solution conveying apparatus, used for conveying the nanoparticle solution to a surface of the metal workpiece (6) to be processed;
an electrophoresis-assisted apparatus (12), mounted on the working table (1) and respectively connected with an electrophoresis-assisted cathode and the metal workpiece (6) to be processed in a conducting manner, wherein an electrophoresis-assisted electric field for depositing nanoparticles is formed between the metal workpiece (6) to be processed and the electrophoresis-assisted cathode;
a vacuum heating apparatus (10), mounted on the working table (1) and used for heating the metal workpiece (6) to be processed to melt part of the nanoparticles on the surface of the metal workpiece to be processed; and
an integrated control cabinet (11) with a controller arranged therein, wherein the controller is in communication connection with and controls the particle and solution mixing and circulating container (2), the solution conveying apparatus and the vacuum heating apparatus (10).

2. The surface modification device according to claim 1, wherein an ultrasonic vibration apparatus for vibrating the nanoparticles, a magnetic stirring apparatus for stirring the nanoparticle solution, a suspension suction apparatus for guiding the nanoparticle solution, and a solution circulating apparatus for filtering and circulating the nanoparticle solution are arranged in the particle and solution mixing and circulating container (2).

3. The surface modification device according to claim 1, wherein a micro three-dimensional motion platform (9) in communication connection with the controller is mounted on the working table (1); and the processing recess (7) is mounted on the micro three-dimensional motion platform (9), and moves synchronously with the micro three-dimensional motion platform (9) to align the metal workpiece (6) to be processed with the solution conveying apparatus.

4. The surface modification device according to claim 3, wherein a workpiece clamp (8) for clamping the metal workpiece (6) to be processed is fixedly mounted on an upper side of a bottom plate of the processing recess (7).

5. The surface modification device according to claim 4, wherein a main shaft (4) is arranged on the working table (1); the solution conveying apparatus comprises a suction pipe and a suction pipe clamp; an opening defined on one end of the suction pipe is communicated with the particle and solution mixing and circulating container (2); the suction pipe clamp is configured to clamp the other end of the suction pipe, so that an opening defined on the other end of the suction pipe is aligned with the metal workpiece (6) to be processed; and the suction pipe clamp is mounted on the main shaft (4), and is movable along the main shaft (4).

6. The surface modification device according to claim 5, wherein a cathode clamp (5) is mounted on the main shaft (4); the cathode clamp (5) is configured to clamp the electrophoresis-assisted cathode; one output end of the electrophoresis-assisted apparatus (12) is connected with the cathode clamp (5), and the other output end of the electrophoresis-assisted apparatus is connected with the workpiece clamp (8).

7. The surface modification device according to claim 1, wherein a keyboard and a display screen which are in communication connection with the controller are arranged outside the integrated control cabinet (11).

8. The surface modification device according to claim 1, wherein a video detecting apparatus (3) used for detecting states of the nanoparticles on the surface of the metal workpiece (6) to be processed is mounted on the working table (1).

9. The surface modification device according to claim 8, wherein the video detecting apparatus (3) comprises a bracket mounted on the working table (1) and a charge coupled image sensor mounted on the bracket.
